(19) United States
(12) Patent Application Publication
(10) Pub. No.: US 2017/0297217 A1
(43) Pub. Date: Oct. 19, 2017

(54) NON-CIRCULAR HOLE SAW DEVICE AND METHOD OF OPERATION

(71) Applicant: Tyler Bourne, Somerset, KY (US)

(72) Inventor: Tyler Bourne, Somerset, KY (US)

(21) Appl. No.: 15/486,520

(22) Filed: Apr. 13, 2017

Related U.S. Application Data
(60) Provisional application No. 62/322,514, filed on Apr. 14, 2016.

(51) Int. Cl. B27B 19/00; B23D 61/00; B23D 61/18; B26F 1/44

(52) U.S. Cl. CPC B27B 19/008; B26F 1/44; B23D 61/006; B23D 61/18

(57) ABSTRACT

An axially mounted non-circular hole saw device follows a lateral, oscillating cutting motion to cut a non-circular kerf in a workpiece. The device adapts to variously styled power tools. The device couples to a power tool at an axial orientation through a mounting portion. The axial disposition of the device relative to the power tool enables the axial vibratory force generated by the power tool to convert to a lateral, oscillating cutting motion followed by the device. This cutting motion forms a clean non-circular kerf, offsets vibrations during cutting, and minimizes debris formed during cutting. A cutting portion has a non-circular shape. The cutting portion includes a base edge and a teeth edge. A bridge traverses the base edge for stability. A mounting portion extends perpendicularly from the bridge portion. The mounting portion includes a gap defined by slots that couple to a coupling mechanism from the power tool.

### CROSS REFERENCE OF RELATED APPLICATIONS

This application claims the benefits of U.S. provisional application No. 62/322,514, filed Apr. 14, 2016 and entitled AXIALLY MOUNTED NON-CIRCULAR HOLE SAW BLADE, which provisional application is incorporated by reference herein in its entirety.

### FIELD OF THE INVENTION

The present invention relates generally to a non-circular hole saw device that couples to a power tool at an axial orientation to cut a non-circular hole in a workpiece while following an oscillating, lateral cutting action on the workpiece. More so, the non-circular hole saw device provides a saw blade comprises a cutting portion that is configured into at least one non-circular shape; and further provides a mounting portion that is adaptable to couple to different styles of power tools; and further is configured to couple to the power tool at an axial orientation, such that: the axial vibratory forces generated by the power tool convert to a lateral, oscillating cutting motion that is followed by the cutting portion; the lateral, oscillating cutting motion forms a clean non-circular kerf in the workpiece; vibrations from the cutting motion are offset; and minimal debris is formed during cutting.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Typically, a hole saw is a drill accessory that allows a user to make circular cut-outs in a material such as wood, steel, fiberglass, plastic, etc. Hole saws generally range in size from ⅝″ to 6″ in diameter, but are mostly utilized for drilling holes larger than 1″ diameter. Typically, hole saws are adapted to be used with a drill press or power drill.

It is known that a hole saw is often used with a power tool, such as a drill to cut circular holes in a work surface. The hole saws are commonly used by electricians to cut holes through a hard metallic work surface on an electrical panel. Hole saws typically include a cylindrical cutting body mounted on an arbor. The upper, proximal end of the arbor is attached to a key or keyless chuck on the end of a hand drill.

Usually, formed on the circular lower edge of the cutting body is a plurality of angled cutting teeth made of suitable material to cut through a particular work surface. The teeth on the cutting body are pitched at a particular angled to cut through the work surface only when rotated by the drill in a clockwise direction. When the cutting body is rotated in a counter-clockwise direction, the teeth slide over the work surface and do not cut into it.

Other proposals have involved hole saws. The problem with these hole saws is that they vibrate excessively when cutting through a workpiece, which creates an uneven cutting surface. Also, the shape of the formed hole is circular. Even though the above cited hole saws meets some of the needs of the market, a non-circular hole saw device that couples to a power tool at an axial orientation to cut a non-circular hole in a workpiece while following an oscillating, lateral cutting action on the workpiece is still desired.

### SUMMARY

Illustrative embodiments of the disclosure are generally directed to a non-circular hole saw device and method of operation. The non-circular hole saw device provides a unique saw blade that is configured to form non-circular holes in a workpiece while cutting in a lateral, oscillating cutting motion. The device adapts to different styles of power tools, coupling to the power tools at an axial orientation that helps minimize vibrations and sound. The device is also configured to follow a lateral, oscillating cutting motion while cutting a kerf in a workpiece. The axial disposition of the device relative to the power tool enables the axial vibratory force generated by the power tool to convert to a lateral, oscillating cutting motion followed by the device.

In some embodiments, the non-circular hole saw device comprises a cutting portion defined by a generally non-circular shape. The cutting portion comprises a base edge and an oppositely disposed teeth edge. The teeth edge comprise a plurality of teeth disposed in an aligned, spaced apart relationship.

The device further comprises a bridge portion traversing the base edge of the cutting portion. The bridge portion is configured to enhance structural integrity of the device during operation. Specifically, the generally normal disposition of the bridge portion in relation to the cutting portion helps enhance structural integrity of the hole saw device and helps minimize vibratory effects of the hole saw device while in operation.

In some embodiments, the device further comprises a mounting portion that is configured to enable mounting of the device. The mounting portion comprises a tab that extends generally perpendicular from the bridge portion. The tab forms a gap having a gap perimeter, and the gap perimeter is defined by a plurality of slots. The generally perpendicular disposition of the tab in relation to the bridge portion enables axial mounting of the hole saw device.

In another aspect, the generally non-circular shape includes at least one of the following shapes: a square, a rectangle, a triangle, a trapezoid, a star, and a rhombus.

In another aspect, the plurality of teeth are arranged in a plurality of repeating segments.

In another aspect, the bridge portion is generally broad.

In another aspect, the tab forms a plurality of apertures disposed around the gap perimeter.

In another aspect, the tab is configured to form a tapered terminus.

In another aspect, the plurality of slots have uneven lengths.

In another aspect, the mounting portion is disposed generally perpendicular to the bridge portion.

In another aspect, the mounting portion is substantially flat.

In another aspect, the device comprises welded metal.

In another aspect, the device comprises abrasive or corrosion resistant coatings or impregnation.

In another aspect, the workpiece may include: drywall, electric panels, wood, metal studs, foam, paper, polymer, masonry, ceramics, clay, teeth, and organic substrates.

One objective of the present invention is to provide a hole saw device that follows a lateral, oscillating cutting motion.

Another objective is to provide a hole saw device that has at least one non-circular shape.

Another objective is to provide a hole saw device that couples to different styles of power tools at an axial orientation.

Another objective is to form a clean kerf in the workpiece.

Another objective is to dampen vibrations from the power tool while cutting.

Another objective is to minimize debris that forms while cutting.

Another objective is to cut various types of workpieces and substrates.

Another objective is to mount and detach the hole saw device to a power tool with no tools and a minimal skill set.

Another objective is to provide a hole saw device that enables precision, speed, no learning curve, and compatibility with existing systems.

Another objective is to provide an inexpensive to manufacture hole saw device.

Yet another objective is the provision of a hole saw which is simple in construction, which is inexpensive to manufacture, and which is capable of a long life of useful service with a minimum of maintenance.

Yet another objective is to a provide a hole saw which is relatively easy to manufacture.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### DESCRIPTION OF THE DRAWINGS

The invention will now be described, by way of example, with reference to the accompanying drawings, in which:

FIG. 1 illustrates a perspective view of an exemplary axially mounted hole saw device, in accordance with an embodiment of the present invention;

FIG. 2 illustrates an elevated side view of the axially mounted hole saw device shown in FIG. 1, in accordance with an embodiment of the present invention;

FIG. 3 illustrates an elevated forward view of the axially mounted hole saw device shown in FIG. 1, in accordance with an embodiment of the present invention; and

FIG. 4 illustrates a flowchart of an exemplary method for operation of an axially mounted hole saw device, in accordance with an embodiment of the present invention.

Like reference numerals refer to like parts throughout the various views of the drawings.

### DETAILED DESCRIPTION OF THE INVENTION

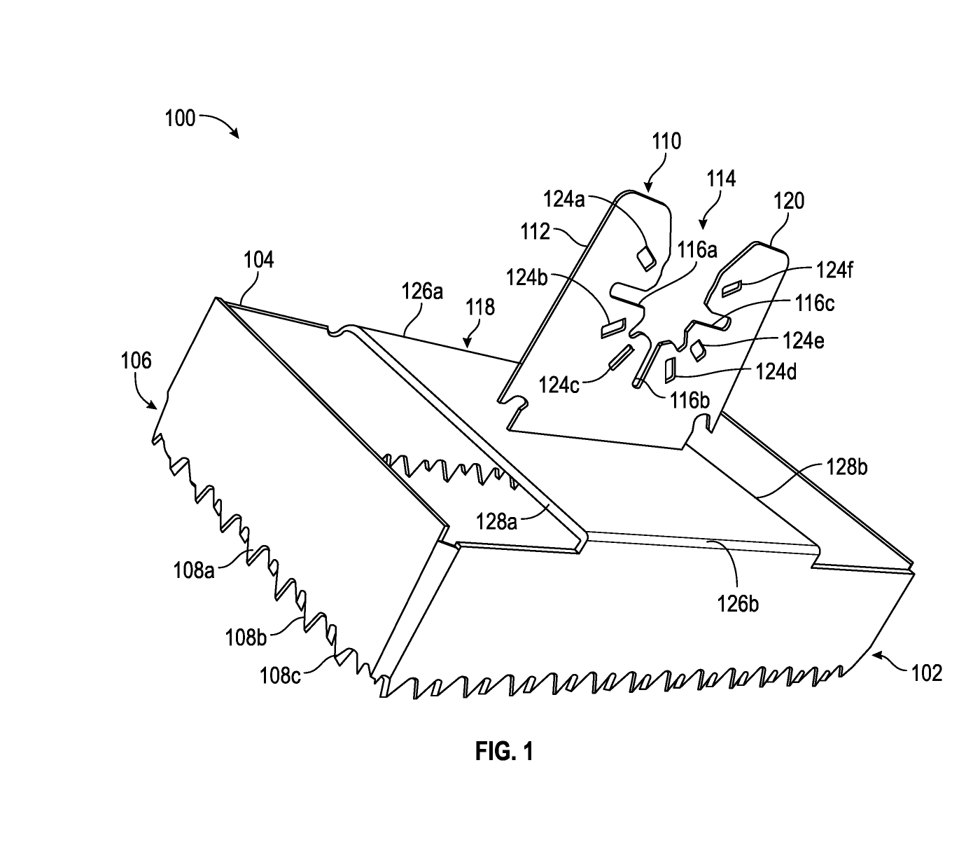

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

At the outset, it should be clearly understood that like reference numerals are intended to identify the same structural elements, portions, or surfaces consistently throughout the several drawing figures, as may be further described or explained by the entire written specification of which this detailed description is an integral part. The drawings are intended to be read together with the specification and are to be construed as a portion of the entire “written description” of this invention as required by 35 U.S.C. §112.

In one embodiment of the present invention presented in FIGS. 1-4, an axially mounted non-circular hole saw device 100 and method 200 of operation provides a unique saw blade that is configured to form non-circular holes in a workpiece while cutting in a lateral, oscillating cutting motion. The axially mounted non-circular hole saw device 100, hereafter “device 100” adapts to different styles of power tools, and also configured to follow a lateral, oscillating cutting motion while cutting a kerf in a workpiece. Device 100 is configured to couple to a power tool at an axial orientation. The axial disposition of the device 100 relative to the power tool enables the axial vibratory force generated by the power tool to convert to a lateral, oscillating cutting motion followed by the device 100.

There are numerous advantageous that the lateral, oscillating cutting motion of device 100 offers. For one, a clean kerf is formed in the workpiece. Another advantage is that a clean non-circular kerf is formed. Another advantage is that vibrations during cutting are offset. As a result of the minimization of vibrations, debris that is formed during the cutting process is reduced.

As referenced in FIG. 1, the device 100 comprises a cutting portion 102 that can be configured to form at least one non-circular shape. The non-circular shape of the cutting portion 102 allows for eclectic operational uses of the device 100. In one embodiment, a generally square perimeter shape of the cutting portion 102 forms a square electrical gap 114, such as used for residential light switches. In some embodiments, the non-circular shape may include, without limitation, a square, a rectangle, a triangle, a trapezoid, a star, and a rhombus.

In some embodiments, cutting portion 102 may include a base edge 104 and a teeth edge 106. Teeth edge 106 may include a plurality of teeth 108a, 108b, 108c that are arranged in repeating segments to perform the cutting action on the workpiece. Base edge 104 is disposed opposite teeth edge 106. In one embodiment, a sidewall extends from base edge 104 to teeth edge 106. Suitable materials for cutting portion 102 may include, without limitation, steel, tungsten alloy, carbon metal, iron, and metal alloys. The cutting portion 102 may also be treated with an abrasive or corrosion resistant coatings or impregnation.

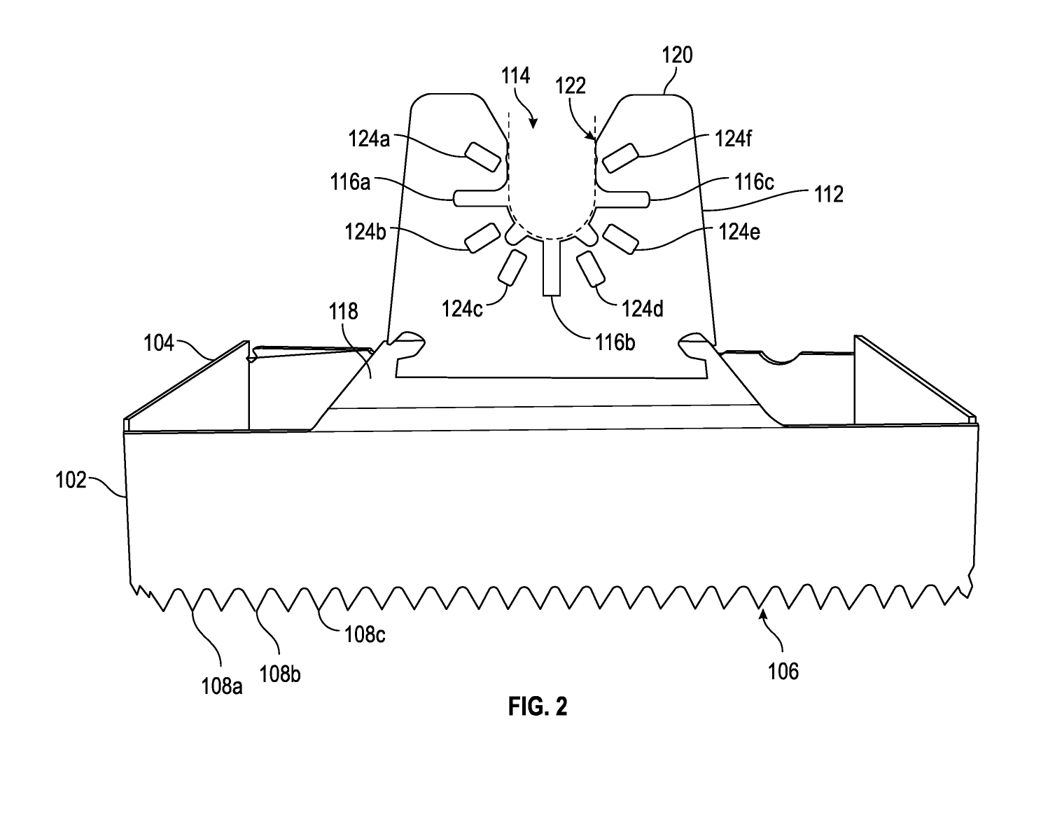

Looking now at FIG. 2, device 100 further comprises a bridge portion 118 that traverses the base edge 104 of the cutting portion 102. Bridge portion 118 is generally broad, which enhances the structural integrity of cutting portion 102 and helps minimize vibratory effects from the power tool while cutting the workpiece.

In one alternative embodiment, bridge portion 118 may be configured to be partially or fully enclosed with or without the perforation of base edge 104. While fully enclosed, bridge portion 118 may include a vacuum port that receives a vacuum assembly to suck excessive dust and debris from the cutting operation. The vacuum assembly provides a means of sterile, central dust free cutting operation. Further, the vacuum port may be designed with or without a counterweight fixed on the opposing side of cutting portion 102.

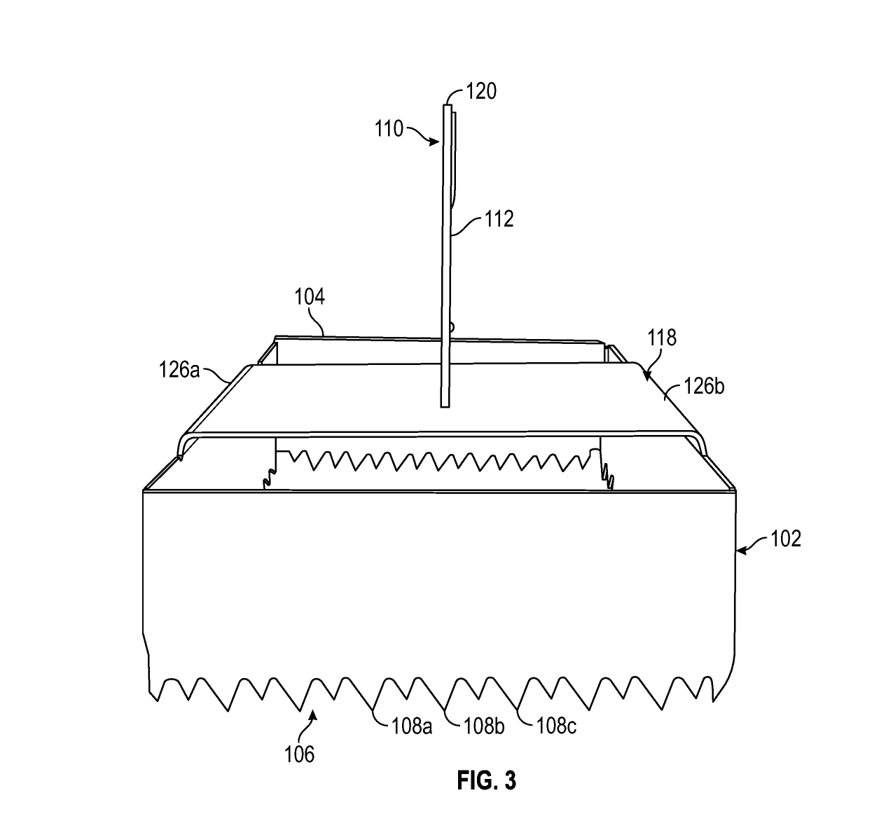

As illustrated in FIG. 3, device 100 may further comprise a mounting portion 110 that is adaptable to detachably couple to different styles of power tools. Mounting portion 110 may include a tab 112 that extends perpendicularly from the base edge 104 of the cutting portion 102. Tab 112 terminates at a tapered terminus 120. Tab 112 is defined by a gap 114 having a gap perimeter 122. Gap perimeter is defined by a plurality of slots 116a, 116b, 116c and a plurality of apertures 124a, 124b, 124c, 124d, 124e, 124f that help interlock mounting portion 110 with a power tool. Tab 112 may also form a tapered terminus that couples directly into a power tool.

In one embodiment, the power tool includes a coupling mechanism, such as a drill chuck that enables the power tool to detachably couple to device 100 through gap 114. The slots 116a, 116b, 116c in the perimeter of gap 114 are configured to align and misalign with a plurality of protrusions from the coupling mechanism of the power tool. In one embodiments, the lengths of slots 116a-c are different. This coupling means enables rotatable locking and detachment of device 100 from the power tool.

In operation, device 100 is used to cut a non-circular section out of a work piece. Device 100 is used with a power tool, such as a drill, to cut circular holes in a work surface. Those skilled in the art will recognize that these types of holes are commonly used by electricians to cut holes through a hard metallic work surface on an electrical panel. The workpiece may include, without limitation, drywall, electric panels, wood, metal studs, foam, paper, polymer, masonry, ceramics, clay, and organic substrates.

As referenced in FIG. 1, the hole saw device 100 is an “open hole” style saw blade that cuts gaps in various workpieces and substrates. Those skilled in the art will recognize that a hole saw is often used in the construction industry for drilling holes that have a diameter of larger than 9/16″. Most commonly, hole saws are utilized for providing holes in drywall, electric panels, wood, and metal studs. The holes for such endeavors must be drilled accurately and quickly. This enables the workpiece to be smooth around the area of the drilled hole.

As FIG. 2 shows, device 100 comprises a cutting portion 102 that may be configured into at least one non-circular shape. Cutting portion 102 may include a base edge 104 and a teeth edge 106. Teeth edge 106 may include a plurality of teeth 108a, 108b that are arranged in repeating segments to perform the cutting action on the workpiece. Though in other embodiments, any serrated configuration for teeth 108a, 108b may be used. In one embodiment, cutting portion 102 is welded metal. In another embodiment, cutting portion 102 comprises abrasive or corrosion resistant coatings or impregnation.

The unique non-circular shape of cutting portion 102 allows for eclectic operational uses of device 100. In some embodiments, the cutting portion 102 is scalable, so as to cut non-circular holes ranging in size from ⅝″ to 6″ in diameter, but is mostly utilized for drilling holes larger than 1″ diameter.

In one exemplary non-circular shape of cutting portion 102, a generally square perimeter shape of cutting portion 102 forms a square electrical gap, such as used for residential light switches. In another example, a generally rectangular perimeter shape may form a kerf for a circuit box that is set behind a wall. In yet another example, a star perimeter shape may be used to cut a depression in a tooth for setting gold fillings. In any case, the cutting is generally smooth, with minimal vibratory effects from the power tool.

Cutting portion 102 is configured to follow a lateral, oscillating cutting motion while cutting a kerf in a workpiece. Because device 100 couples to the power tool at an axial orientation, the axial disposition of device 100 relative to the power tool enables the axial vibratory force generated by the power tool to convert to a lateral, oscillating cutting motion followed by cutting portion 102. This lateral, oscillating cutting motion provides numerous advantageous for operation on the workpiece, and especially forming a kerf in the workpiece. The lateral, oscillating cutting motion forms a clean non-circular kerf, offsets vibrations from the cutting, and minimizes debris that is formed during cutting.

Looking back at FIG. 1, device 100 comprises a bridge portion 118 that traverses the base edge 104 of the cutting portion 102. Bridge portion 118 is defined by a pair of short ends 126a, 126b and a pair of long sides 128a, 128b. Bridge portion 118 is generally broad from side 128a to side 128b.

For example, as bridge portion 118 traverses the gap formed across the base edge 104 of cutting portion 102, about 20% of the gap may be covered. The general broadness of bridge portion 118 enhances structural integrity of cutting portion 102 and helps minimize vibratory from the power tool effects while cutting the workpiece. In one embodiment, bridge portion 118 is welded metal. In another embodiment, bridge portion 118 comprises abrasive or corrosion resistant coatings or impregnation.

As illustrated in FIG. 3, device 100 may further comprise a mounting portion 110 that is adaptable to detachably couple to different styles of power tools. Mounting portion 110 may include a tab 112 that extends perpendicularly from the base edge 104 of the cutting portion 102. Tab 112 is generally flat and rigid, so as to from a stable connection with the coupling mechanism of the power tool. In one embodiment, tab 112 is defined by a gap 114 having perimeter that is defined by a plurality of slots 116a, 116b, 116c. Tab 112 may form a plurality of apertures disposed around the gap perimeter. Tab 112 extends up from bridge portion, up to a terminus 120.

In one exemplary mounting adaptation, a power tool (not shown) mounts to device for non-circular sawing of a hole. The power tool includes a coupling mechanism, such as a drill chuck, that enables the power tool to detachably couple to the gap 114 in tab 112. The slots 116a, 116b, 116c in the perimeter of gap 114 are configured to align and misalign with a plurality of protrusions from the coupling mechanism of the power tool. This coupling means enables rotatable locking and detachment of device 100 from the power tool. In one embodiment, mounting portion 110 is welded metal. In another embodiment, mounting portion 110 comprises abrasive or corrosion resistant coatings or impregnation.

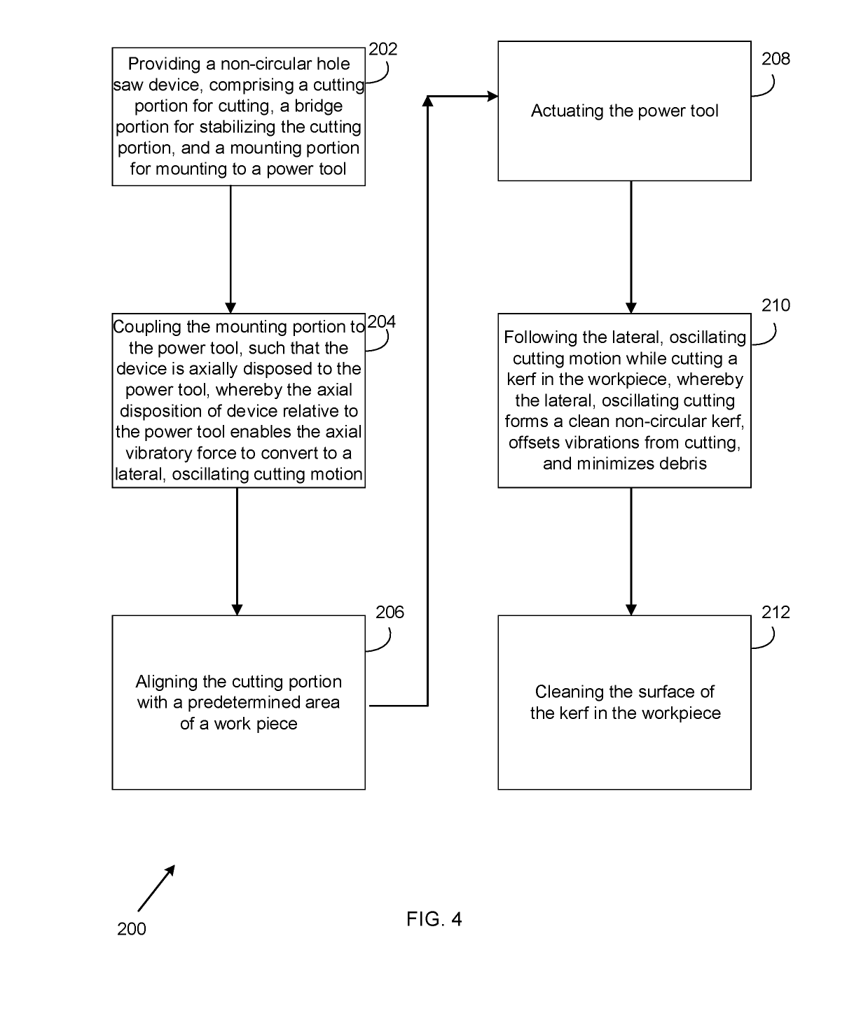

FIG. 4 illustrates a flowchart of an exemplary method 200 for operation of a non-circular hole saw device. Method 200 may include an initial Step 202 of providing a non-circular hole saw device, the hole saw device comprising a cutting portion, a bridge portion, and a mounting portion. Method 200 may further comprise a Step 204 of coupling the mounting portion to the power tool, such that the device is axially disposed to the power tool, whereby the axial disposition of device relative to the power tool enables the axial vibratory force generated by the power tool to convert to a lateral, oscillating cutting motion followed by cutting portion.

In some embodiments, a Step 206 includes aligning the cutting portion with a predetermined area of a work piece. A Step 208 comprises actuating the power tool. A Step 210 includes following the lateral, oscillating cutting motion while cutting a kerf in the workpiece, whereby the lateral, oscillating cutting motion forms a clean non-circular kerf, offsets vibrations from the cutting, and minimizes debris that is formed during cutting. A final Step 212 includes cleaning the surface of the kerf in the workpiece.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What I claim is:

1. A non-circular hole saw device, the device comprising:
a cutting portion defined by a generally non-circular shape, the cutting portion comprising a base edge and an oppositely disposed teeth edge, the teeth edge comprising a plurality of teeth disposed in an aligned, spaced apart relationship;
a bridge portion defined by a pair of short ends and a pair of long sides, the bridge portion disposed to traverse the base edge of the cutting portion,
whereby the generally normal disposition of the bridge portion in relation to the cutting portion helps enhance structural integrity of the hole saw device and helps minimize vibratory effects of the hole saw device while in operation; and
a mounting portion configured to enable mounting of the device, the mounting portion comprising a tab, the tab extending generally perpendicular from the bridge portion, the tab forming a gap having a gap perimeter, the gap perimeter defined by a plurality of slots,
whereby the generally perpendicular disposition of the tab in relation to the bridge portion enables axial mounting of the hole saw device.

2. The device of claim 1, wherein the generally non-circular shape includes at least one of the following shapes: a square, a rectangle, a triangle, a trapezoid, a star, and a rhombus.

3. The device of claim 1, wherein the plurality of teeth are arranged in a plurality of repeating segments.

4. The device of claim 1, wherein the bridge portion is generally broad.

5. The device of claim 1, wherein the tab forms a plurality of apertures disposed around the gap perimeter.

6. The device of claim 1, wherein the tab is configured to form a tapered terminus.

7. The device of claim 1, wherein the plurality of slots have uneven lengths.

8. The device of claim 1, wherein the mounting portion is disposed generally perpendicular to the bridge portion.

9. The device of claim 1, wherein the mounting portion is substantially flat.

10. The device of claim 1, wherein the device comprises welded metal.

11. The device of claim 1, wherein the device comprises abrasive or corrosion resistant coatings or impregnation.

12. The device of claim 1, wherein the workpiece includes at least one member selected from the group consisting of: drywall, electric panels, wood, metal studs, foam, paper, polymer, masonry, ceramics, clay, teeth, and organic substrates.

13. A non-circular hole saw device, the device consisting of:
a cutting portion defined by a generally non-circular shape, the generally non-circular shape including at least one of the following shapes: a square, a rectangle, a triangle, a trapezoid, a star, and a rhombus, the cutting portion comprising a base edge and an oppositely disposed teeth edge, the teeth edge comprising a plurality of teeth disposed in an aligned, spaced apart relationship;
a bridge portion traversing the base edge of the cutting portion,
whereby the generally normal disposition of the bridge portion in relation to the cutting portion helps enhance structural integrity of the hole saw device and helps minimize vibratory effects of the hole saw device while in operation; and
a mounting portion configured to enable mounting of the device, the mounting portion comprising a tab, the tab extending generally perpendicular from the bridge portion, the tab forming a gap having a gap perimeter, the gap perimeter defined by a plurality of slots, the tab further forming a plurality of apertures disposed around the gap perimeter,
whereby the generally perpendicular disposition of the tab in relation to the bridge portion enables axial mounting of the hole saw device.

14. The device of claim 13, wherein the mounting portion is substantially flat.

15. The device of claim 13, wherein the device comprises welded metal.

16. The device of claim 13, wherein the device comprises abrasive or corrosion resistant coatings or impregnation.

17. A method for operation of a non-circular hole saw device, the method comprising:
providing a non-circular hole saw device, the hole saw device comprising a cutting portion for cutting, a bridge portion for stabilizing the cutting portion, and a mounting portion for mounting to a power tool;
coupling the mounting portion to the power tool, such that the device is axially disposed to the power tool, whereby the axial disposition of device relative to the power tool enables the axial vibratory force generated by the power tool to convert to a lateral, oscillating cutting motion followed by cutting portion;
aligning the cutting portion with a predetermined area of a work piece;
actuating the power tool;
following the lateral, oscillating cutting motion while cutting a kerf in the workpiece, whereby the lateral, oscillating cutting motion forms a clean non-circular kerf, offsets vibrations from the cutting, and minimizes debris that is formed during cutting; and
cleaning the surface of the kerf in the workpiece.
